(19) United States
(12) Patent Application Publication
(10) Pub. No.: US 2006/0282465 A1
(43) Pub. Date: Dec. 14, 2006

(54) System and method for searching media content

(75) Inventor: Anshuman Sharma, San Francisco, CA (US)

Correspondence Address: KIRKPATRICK & LOCKHART NICHOLSON GRAHAM LLP, 535 SMITHFIELD STREET, PITTSBURGH, PA, 15222, US

(73) Assignee: Corescient Ventures, LLC

(21) Appl. No.: 11/151,997

(22) Filed: Jun. 14, 2005

(51) Int. Cl. G06F 7/00

(52) U.S. Cl. 707/104.1

(57) ABSTRACT

A system for determining the existence of pre-determined media content within a media content collection. The system includes a media content processing module configured for collecting one or more media content files from one or more external peer-to-peer networks to form the media content collection, generating one or more classification parameter values based upon a corresponding one or more attributes for each of the one or more collected media content files, applying one or more parsing algorithms to at least one of the media content file and the one or more classification parameter values corresponding thereto for each of the one or more collected media content files, and generating one or more searchable indices based upon outputs from the one or more parsing algorithms. The system also includes a media content search module in communication with the media content processing module configured for applying a search algorithm to at least one of the one or more searchable indices based upon one or more search strings input thereto.

### TECHNICAL FIELD OF THE INVENTION

The present invention is directed generally and in various embodiments to a system and method for determining the existence of pre-determined media content within a media content collection.

### BACKGROUND

A peer-to-peer (P2P) network is a communications environment that allows all parties, or “hosts,” on the network to act as quasi-servers and, consequently, share their files with other hosts on the network. Each host generally has the same communication-initiation capabilities and, hence, any host may typically initiate a communication session. In that way, P2P networks differ from conventional client-server architectures characterized by a centralized server for serving files to connected users, or “clients.” Two main models of P2P networks for file sharing have evolved: (1) the centralized server-client model in which a single server system maintains directories of the shared files stored on the respective hosts (but does not serve the files to the hosts), and (2) the decentralized model which does not include a central server system.

Currently, there exist P2P search engines that enable a host to search files stored by other hosts. Searching on a centralized system is made relatively easy by the presence of the central server system. When a host searches for a file, the central server creates a list of files matching the search request by cross-checking the request with the server's database of files belonging to other hosts currently connected to the network. The central server then displays that list to the requesting host. The requesting host can then choose files from the list and make direct connections to the individual computers which currently possess those files.

In a decentralized network, when a first host connects to a decentralized network it typically connects to a second host to announce that it is active. The second host will then in turn announce to all hosts to which it is connected (e.g., a third, fourth, and fifth host) that the first host is active. The third, fourth, and fifth hosts repeat the pattern. Once the first host has announced that it is on the network, it can send a search request on to the second host, which in turn passes the request on to the third, fourth, and fifth hosts. If, for example, the third host has a copy of the requested file, it may transmit a reply to the second host, which passes the reply back to the first host. The first host may then open a direct connection with the third host and download the file.

Such P2P searching mechanisms, however, only search for files based on metadata. In some applications, it would be useful to search based on other attributes, such as the content of the files.

### SUMMARY

In one general aspect, the present invention is directed to a system for determining the existence of pre-determined media content within a media content collection. According to various embodiments, the system includes a media content processing module and a media content search module. The media content processing module is configured for collecting media content files from external peer-to-peer networks to form the media content collection. The media content processing module is further configured for generating a number of classification parameter values based upon corresponding attributes for each of the collected media content files. The media content processing module is also configured for applying one or more parsing algorithms to each media content file and/or to the classification parameter values for each media content file. The media content processing module is further configured for generating one or more searchable indices based upon outputs from the parsing algorithms. The media content search module is configured for applying a search algorithm to one or more of the searchable indices based upon search strings input to the search algorithm.

In another general aspect, the present invention is directed to a method of determining the existence of pre-determined media content within a media content collection. According to various embodiments, the method includes the step of collecting one or more media content files from external peer-to-peer networks to form the media content collection. The method also includes the step of generating one or more classification parameter values based upon corresponding attributes for each collected media content file. The method further includes the step of applying one or more parsing algorithms to each media content file and/or to the classification parameter values for each media content file. The method further includes the steps of generating one or more searchable indices based upon outputs from the parsing algorithms and applying a search algorithm to one or more of the searchable indices based upon search strings input to the search algorithm.

### DESCRIPTION OF THE FIGURES

Various embodiments of the present invention will be described by way of example in conjunction with the following figures, wherein:

FIG. 1 illustrates a content-based search system, according to various embodiments;

FIG. 2 illustrates various embodiments of the parser of FIG. 1; and

FIG. 3 illustrates a block diagram of the relevancy sorter of FIG. 1, according to various embodiments.

### DESCRIPTION

Embodiments of the present invention generally relate to content-based search systems and associated methods for determining the existence of pre-determined media content within a body of media content collected from one or more P2P networks. As used herein, “media content” refers generally to any information capable of being embodied in a digital format and exchanged between hosts within a P2P network. Typically, media content is exchanged between the hosts in the form of a media content file (MCF). Examples of MCFs may include, without limitation, audio MCFs (e.g., music, voice), image MCFs (e.g., photographs, drawings, scanned images), video MCFs (e.g., movies), document MCFs (e.g., handwritten and/or printed text), and any combination thereof. As used herein, “pre-determined media content” generally refers to any media content that is known and with respect to which there is a need to ascertain its existence, in whole or in part, within a media content collection comprising one or more MCFs. According to various embodiments, for example, pre-determined media content may include copy-protected media content files (CPMCFs) that are subject to restrictions with respect to use, copying, and/or distribution. Such restrictions may arise, for example, by way of agreement and/or under one or more applicable laws, such as, for example, copyright laws. Thus, it may be desirable to determine, for example, whether P2P network hosts are using, copying or distributing such content media unlawfully and/or in violation of an agreement.

For the sake of example in the discussion that follows, pre-determined media content is presented in the context of one or more CPMCFs. It will be appreciated that predetermined media content is not limited to CPMCFs and may also include media content that is not subject to any restrictions. The terms “P2P media content” and “P2P MCF” generally refer to media content that may be obtained via a P2P network. Unless otherwise noted, the terms “media content” and “MCF” generally encompass both copy-protected and P2P media content.

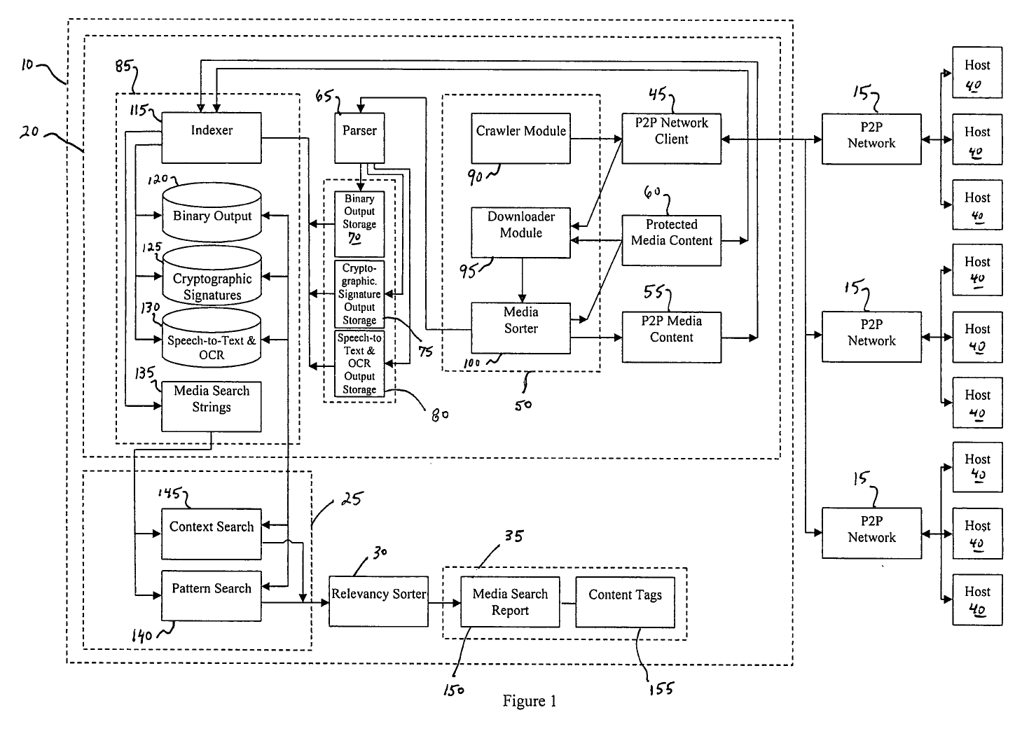

FIG. 1 illustrates a content-based search system 10, according to various embodiments. As shown, the system 10 may be in communication with one or more P2P networks 15. The system 10 may be implemented as one or more networked computer devices and, as shown in FIG. 1, comprise a media content processing module 20, a media content search module 25, a relevancy sorter module 30, and a relevancy output module 35. Functions of the media content processing module 20 may include collecting a body of P2P MCFs via the P2P networks 15 and processing the collected P2P MCFs in order to create one or more searchable indices. The media content search module 25 may enable searching of the one or more indices in accordance with one or more media search strings input thereto. The media search strings may be derived, for example, from one or more CPMCFs. The relevancy sorter module 30 and the relevancy output module 35 may rank and present all or a portion of the collected P2P MCFs based upon, among other things, their similarity to a given CPMCF.

According to various embodiments, one or more of the P2P networks 15 may be a publicly accessible Internet-based P2P network, such as, for example, Kazaa, Morpheus, and eDonkey, for facilitating the exchange of P2P MCFs between P2P network hosts 40 associated therewith. Each P2P network host 40 may be, for example, any network-enabled device having P2P communication capabilities. Each P2P network host 40 may store one or more P2P MCFs that may be accessed and retrieved by other similarly-configured P2P network hosts within the same P2P network 15. The number of P2P networks 15 and corresponding P2P network hosts 40 of FIG. 1 is shown by way of example only, and it will be appreciated that the system 10 may communicate with a greater or lesser number of P2P networks 15 and corresponding P2P network hosts 40.

As shown, the media content processing module 20 may include a P2P network client 45, a media content harvesting and sorting module 50, first and second media content storage devices 55, 60, a parser 65, binary, cryptographic signature, and speech-to-text & OCR output storage devices 70, 75, 80, respectively, and an indexing module 85. According to various embodiments, the P2P network client 45 may be any suitable network-enabled device having P2P communication capabilities similar or identical to those of the P2P network hosts 40. For example, the P2P network client 45 may be a network-enabled computer configured with a P2P browser application for enabling communication with any of the P2P network hosts 40 via their respective P2P networks 15. The presence of the P2P network client 45 on any of the P2P networks may resemble that of a P2P network host 40. As such, the P2P network client 45 may generally access and retrieve any P2P MCF that is accessible and retrievable by other P2P network hosts 40.

As shown, the media content harvesting and sorting module 50 may comprise a crawler module 90, a downloader module 95, and a media sorter module 100. The crawler module 90 may be configured to communicate with the one or more P2P networks 15 via the P2P network client 45 and to automatically collect network topology information from each. Network topology information may include, for example, the network address, the port, and the number of available P2P MCFs associated with each P2P network host 40. The crawler module 90 may further be configured to automatically control the navigation of the P2P network client 45 by directing and managing its communication with the one or more P2P network hosts 40 based on the collected network topology information. As the crawler module 90 controls the navigation of the P2P network client 45, the downloader module 95 may be in communication with the P2P network client 45 and be configured to identify and download available P2P MCFs from the one or more P2P network hosts 40.

The media sorter module 100 may be in communication with the downloader module 95 and configured to receive downloaded P2P MCFs therefrom. The media sorter module 100 may further be configured to classify received P2P MCFs in accordance with one or more media content classification parameters. Examples of media content classification parameters may include MCF attributes (e.g., file name, file size), general MCF types (e.g., music, photograph, document), and MCF formats (e.g., MP3, JPG, DOC). According to various embodiments, the media sorter module 100 may additionally be configured to generate a media file identification number (MFIDN) that serves to uniquely identify each P2P MCF processed thereby. According to such embodiments, the MFIDN may be generated by the media sorter module 100 arbitrarily, or by applying a suitable hash algorithm to the contents of the P2P MCF. According to other embodiments, the MFIDN may be generated by other components of the system 10, such as, for example, the P2P network client 45, the crawler module 90, or the downloader module 95, and may be transferred to the media sorter module 100 along with the P2P MCF.

The first media content storage device 55 may be in communication with the media sorter module 100 and configured to receive and store P2P MCFs obtained from the P2P network hosts 40, along with their corresponding classification parameter and MFIDN values, as output by the media sorter module 100. According to various embodiments, the first media content storage device 55 may comprise any suitable memory-based storage means, such as, for example, a magnetic, optical, or electronic memory storage device, for storing received information so that it may be accessed and retrieved by the system 10 during subsequent processing steps.

The second media content storage device 60 may be in communication with the downloader module 95 and the media sorter module 100 and configured to receive and store, among other things, one or more CPMCFs provided by a client user of the system 10. According to various embodiments, the second media content storage device 60 may be similar to the first media content storage device 55 and comprise any suitable memory-based storage means, such as, for example, a magnetic, optical, or electronic memory storage device, for storing received information so that it may be accessed and retrieved by the system 10 during subsequent processing steps. The one or more CPMCFs may be provided by a client user, for example, based on a need to ascertain if media content contained in any of the CPMCFs exist, in whole or in part, within any of the P2P MCFs stored in the first media content storage device 55.

According to various embodiments, the one or more CPMCFs may initially be uploaded to the P2P network client 45 via physical storage media (e.g., a compact disk) supplied by the client user, or alternatively, via one or more of the P2P networks 15 or other non-P2P networks in communication with the P2P network client 15. According to such embodiments, each CPMCF may be downloaded from the P2P network client 45 by the downloader module 95, classified by the media sorter module 100 in accordance with the media content classification parameters, and assigned a MFIDN. These steps may be performed in a manner similar to that described above with respect to the P2P MCFs stored in the first media content storage device 55. Each CPMCF, along with its corresponding classification parameter and MFIDN value, may be received from the media sorter module 100 by the second media content storage device 60 for storage therein.

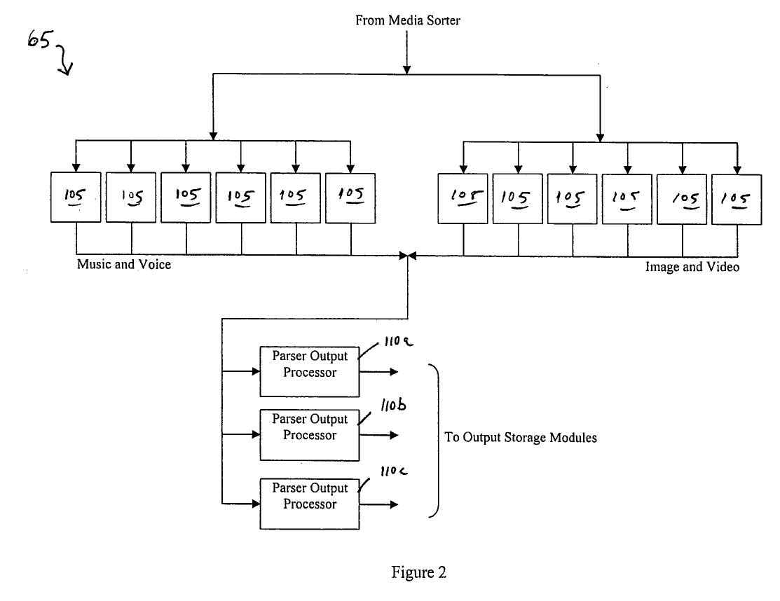

FIG. 2 illustrates various embodiments of the parser 65 of FIG. 1. The parser 65 may be in communication with the media sorter module 100 and configured to receive MCFs and corresponding classification parameter values therefrom. As shown in FIG. 2, embodiments of the parser 65 may comprise one or more parser modules 105 and one or more parser output processor modules 110a-c. Each parser module 105 may be configured to parse a MCF of a particular type and format (e.g., a photograph in a JPG format). As shown, the parser modules 105 may be grouped based on the general MCF type processed by each. For example, a first group of parser modules 105 may be configured to parse music and voice MCF types, and a second group of parser modules 105 may be configured to parse image and video MCF types. Each MCF received by the parser 65 may thus be routed to the appropriate group of parser modules 105 based upon its file type as indicated by the appropriate classification parameter. Following the parser grouping example presented above, a MP3 MCF (music) and a MPEG MCF (movie) may be routed to the first and second group of parser modules 105, respectively. Within each group of parser modules 105, each MCF may be directed to the appropriate parser module 105 based upon its particular type and format. It will be appreciated that the parser module 105 groupings of FIG. 2 are shown by way of example only, and that additional and/or alternative groupings of parser modules 105 may be desirable.

According to various embodiments, each parser module 105 may apply one or more of the following parsing algorithms to MCFs and/or to their corresponding file attributes:

File Format Reader Parsing Algorithm

Cryptographic Signature Hashing Parsing Algorithm

Binary Output Conversion Parsing Algorithm

Speech-to-Text Conversion Parsing Algorithm

Optical Character Recognition Parsing Algorithm

Voice/Sound Capture Recognition Parsing Algorithm

Video/Image Capture Recognition Parsing Algorithm

File Format Reader Parsing Algorithm

A parser module 105 configured to apply the file format reader parsing algorithm may first open the MCF and perform a direct read of its contents (i.e., without “playing” the contents). The MCF contents read by the parser module 105 may include Meta data and/or formatting tags, along with the raw file data. The parser module 105 may next process the contents by removing the Meta data and/or formatting tags so that only the raw file data remains. The raw file data may be output as a data string, converted into a binary string, and output to the parser output processor module 110a. The parser output processor module 110a may be configured to write the binary string corresponding to the raw file data to a flat file contained within the binary output storage device 70 of FIG. 1. The file may be written to the binary output storage device 70, for example, as an array of XML-formatted data. Other information relating to the MCF, such as, for example, Meta data and file attributes, may be stored within the context of specific XML tags for use during the subsequent indexing process. According to various embodiments, the binary output storage device 70 may comprise any suitable memory-based storage means, such as, for example, a magnetic, optical, or electronic memory storage device, for storing the received information so that it may be accessed and retrieved by the system 10 during subsequent processing steps.

Cryptographic Signature Hashing Parsing Algorithm

One or more of the parser modules 105 may apply a cryptographic signature hashing algorithm wherein one more attributes of a MCF (e.g., file name, file size, file Meta data) are hashed to create a unique signature for each. Each hash may be performed using known cryptographic and/or encoding techniques such as, for example, MD5, SHA1, CRC, and X.509 certificates. Each signature may be converted into a binary string and output to the parser output processor module 110b. The parser output processor module 1110b may be configured to write the binary strings corresponding to the signatures to a flat file contained within the cryptographic signature output storage device 75 of FIG. 1. The file may be written to the cryptographic signature output storage device 75, for example, as an array of XML-formatted data. Other information relating to the MCF, such as, for example, Meta data and file attributes, may be stored within the context of specific XML tags for use during the subsequent indexing process. According to various embodiments, the cryptographic signature output storage device 75 may be similar or identical to the binary output storage device 70 and comprise any suitable memory-based storage means for storing the received information so that it may be accessed and retrieved by the system 10 during subsequent processing steps.

Binary Output Conversion Parsing Algorithm

One or more of the parser modules 105 that are configured for processing playable MCFs (e.g., file types that may be played using a compatible media content player, such as music, voice, and video file types) may apply a binary output conversion parsing algorithm. Applying this algorithm, a media stream generated by playing the MCF using a compatible media content player is converted into a binary string and then output to the parser output processor module 110a. The parser output processor module 110a may then write the binary string corresponding to the media stream to a flat file contained within the binary output storage device 70 of FIG. 1. The file may be written to the binary output storage device 70, for example, as an array of XML-formatted data. Other information relating to the MCF, such as, for example, Meta data and file attributes, may be stored within the context of specific XML tags for use during the subsequent indexing process.

Speech-to-Text Conversion Parsing Algorithm

One or more of the parser modules 105 that are configured for processing voice MCF types may apply a speech-to-text conversion algorithm wherein a media stream generated by playing the MCF using a compatible media content player is processed by a speech-to-text parser. The conversion algorithm may be similar, for example, to speech-to-text conversion algorithms used in diction software packages and may utilize phonetic-based techniques for processing speech one syllable at a time. The conversion algorithm may be applied multiple times to the media stream and incorporate a noise reduction algorithm for removing noise components therefrom prior to its conversion into text. With each application of the conversion algorithm, the noise component of the media content player output may be progressively reduced until the noise component is less than a pre-determined threshold, typically 1%. Text output generated by each application of the conversion algorithm may be stored in corresponding text arrays.

Next, the text arrays may be read and each word tested through a playback system so that it may be evaluated against the original media stream. Each word that is determined as the closest match may be verified against a dictionary. If no dictionary match is found, words from the same position in the other text arrays may be tested for a dictionary match. If no dictionary match is found, the most accurate word (i.e., the word with the most noise filtered out) may be selected. Text content generated by this verification process may be output as text stream, converted into a text file, and then output to the parser output processor module 110c. The parser output processor module 110c may be configured to write the text file corresponding to the voice content to a flat file contained within the speech-to-text & OCR output storage device 80 of FIG. 1. The file may be written to the speech-to-text & OCR output storage device 80, for example, as an array of XML-formatted data. Other information relating to the MCF, such as, for example, Meta data and file attributes, may be stored within the context of specific XML tags for use during the subsequent indexing process. According to various embodiments, the speech-to-text & OCR output storage device 80 may be similar or identical to the binary and cryptographic signature output storage devices 70, 75 and comprise any suitable memory-based storage means for storing the received information so that it may be accessed and retrieved by the system 10 during subsequent processing steps.

Optical Character Recognition Parsing Algorithm

One or more of the parser modules 105 that are configured for processing image or video MCF types may apply an optical character recognition (OCR) algorithm wherein an image (or a series of images in the case of a video) is input into an OCR recognition engine. In the case of video MCF types, the MCF may be separated into individual frames, with each frame having an identifying file number and a sequence number tag. Recognized characters output from the OCR recognition engine may be processed by a text recognition algorithm configured to verify each character against known alphanumeric characters in order to form a character stream. As with the speech-to-text conversion algorithm, the OCR algorithm may be applied multiple times and incorporate a noise reduction algorithm for removing noise components from each processed image. With each application of the OCR algorithm, image noise may be progressively reduced until it is less than a pre-determined threshold, typically 3%. Character streams corresponding to each application of the OCR algorithm may be processed using a word creation algorithm for separating the character stream into words based upon, for example, character spacing. Output from the word creation algorithm may be stored in arrays for subsequent processing.

The arrays corresponding to the multiple applications of the OCR and word creation algorithms may be read checked against a character set function in order to determine the proper dictionary language. After the proper dictionary language is determined, each word in a given array may be tested to determine a dictionary match. If no dictionary match is found, words from the same position in other arrays may be tested for a dictionary match. If no dictionary match is found, the most accurate word (i.e., the word with the most noise filtered out) is selected. Text content generated by this testing process may be output as text string, converted into a text file, and output to the parser output processor module 110c. The parser output processor module 110c may be configured to write the text file corresponding to the voice content to a flat file contained within the speech-to-text & OCR output storage device 80 of FIG. 1. The file may be written to the speech-to-text & OCR output storage device 80, for example, as an array of XML-formatted data. Other information relating to the MCF, such as, for example, Meta data and file attributes, may be stored within the context of specific XML tags for use during the subsequent indexing process.

Voice/Sound Capture Recognition Parsing Algorithm

One or more of the parser modules 105 that are configured for processing voice or sound MCF types may apply a voice/sound capture recognition parsing algorithm wherein a media stream generated by playing the MCF using a compatible media content player is parsed into one or more separate data streams. Each data stream may correspond, for example, to a voice and/or sound present in the media stream. Parsing may be performed, for example, using an algorithm that is similar to the algorithm used for the speech-to-text conversion, with the exception that the algorithm is specifically designed to distinguish and separate different voices and sounds. Each output data stream may be passed to a learning algorithm for learning speech and sound patterns and for creating corresponding signature bases. Each MCF may be scanned for identifying attributes, such as, for example, frequency, pitch, and syllable changes. Each attribute may be stored as a binary array that represents the signature of the voice or sound. This allows for speech and sound data to be classified based on a voice/sound signature and provides more specific grouping characteristics during indexing. Such capabilities may be useful, for example, where it is desirable to distinguish between two artists performing the same song. The binary arrays may be converted into corresponding binary strings and output to the parser output processor module 110a. The parser output processor module 110a may then write the binary strings to a flat file contained within the binary output storage device 70 of FIG. 1. The file may be written to the binary output storage device 70, for example, as an array of XML-formatted data. Other information relating to the MCF, such as, for example, Meta data and file attributes, may be stored within the context of specific XML tags for use during the subsequent indexing process.

Video/Image Capture Recognition Parsing Algorithm

One or more of the parser modules 105 that are configured for processing image or video MCF types may apply a video/image capture recognition parsing algorithm wherein an image (or a series of images in the case of a video) is input into an image capture engine. In the case of video MCF types, the MCF may be separated into individual frames, with each frame having an identifying file number and a sequence number tag. The parsing algorithm may be similar to that described above with respect to OCR image processing and may be configured to distinguish different images and objects within a given image based upon their respective features such as, for example, distinguishing attributes, shape, color, design complexity, texture, and pattern. Detected instances of such features may be processed by an algorithm that is configured to “learn” the features and to create a unique signature base representative of the image or object. In order to account for variation in modes of form (e.g., a different orientation of an object), the learning algorithm may additionally be configured to extrapolate between known modes of form in order to recognize new (i.e., previously unseen) modes of form. Based upon the learned features, each image processed by the parsing algorithm may be scanned for common image types (e.g., trees, cars, houses, faces), and an image recognition map identifying key feature points within the processed image may be created. Each image map may be output as a binary array that represents the image features. Representation of images in this manner enables the rapid identification of those images within a media content collection that contain similar features.

Learned images and objects, along with the image maps, may be written to a binary array for the corresponding image (i.e., and stored for later access, thus enabling image classification. For each image, the binary array may be converted into corresponding binary string and output to the binary output processor module 110a. The binary output processor module 110a may then write the binary strings to a flat file contained within the binary output storage device 70 of FIG. 1. The file may be written to the binary output storage device 70, for example, as an array of XML-formatted data. Other information relating to the MCF, such as, for example, Meta data and file attributes, may be stored within the context of specific XML tags for use during the subsequent indexing process.

As shown in FIG. 1, the indexing module 85 may comprise an indexer 115, a binary output index 120, a cryptographic signature index 125, a speech-to-text and OCR index 130, and a media search strings module 135. The indexer 115 may be in communication with the output storage devices 70, 75, 80 and the first and second media content storage devices 55, 60 and utilize indexing algorithms for generating searchable indices 120, 125, 130 based on information stored therein. The indices may be created utilizing known hierarchical array structures. For text-based content, individual words may be associated with relational pointers to content segments (e.g., sentences and paragraphs) within a hierarchy. The hierarchy may be structured in a matrix array that describes the content and its coordinates within related files. Binary strings may be stored in a similar fashion, and relational data pointers may be used to identify corresponding text content.

Typically, the parsing and indexing processes are performed twice: once for P2P MCFs and once for CPMCFs. After the P2P MCFs have been parsed as described above, the resulting data may be retrieved by the indexer 115 from the binary, cryptographic signature, and speech-to-text & OCR output storage devices 70, 75, 80 in order to create the corresponding indices 120, 125, 130. During the indexing process, additional data may also be retrieved by the indexer 115 from the first and second media content storage devices 55, 60 for incorporation into the indices 120, 125, 130. Such data may include, for example, the MFIDN and classification parameter values associated with data as it is processed by the indexer 115.

After parsing and indexing of the P2P MCFs is complete, the CPMCFs may be processed by the parser 65 as described above. The resulting data may be retrieved by the indexer 115 from the binary, cryptographic signature, and speech-to-text & OCR output storage devices 70, 75, 80 and processed in order to create media search strings. The media search strings module 135 may be in communication with the indexer 115 and configured to store media search strings generated thereby. According to various embodiments, the indexer 115 may be configured to create one or more media search strings for each CPMCF content file based upon one or more of the outputs generated by the binary output conversion parsing algorithm, the speech-to-text conversion parsing algorithm, the OCR parsing algorithm, the voice/sound capture recognition parsing algorithm, and the video/image capture recognition parsing algorithm. According to various embodiments, media search strings may be created manually by inputting text into a query search interface. Media search strings created in this manner may contain, for example, a description of an image or other object, keywords that may appear within text content, a description of an event, and lyrics from a song, or other text.

As shown in FIG. 1, the media content search module 25 may comprise a pattern search module 140 and a context search module 145. According to various embodiments, the pattern search module 140 may be configured to receive a search string from the media search strings module 135 and to identify data within one or more of the indices 120, 125, 130 containing a pattern identical or similar to a pattern contained in the search string. Identification of similarity between patterns may be based upon, for example, similarity between binary string patterns, text string patterns, hash patterns, shape patterns, and/or color patterns.

According to various embodiments, the context search module 145 may be configured to receive a search string from the media search strings module 135 and to identify data within one or more of the indices 120, 125, 130 containing contextual features identical or similar to those of the search string. Identification of contextual similarity may be based upon, for example, contextual similarity between strings, substrings, words, and phrases.

The relevancy sorter module 30 may be in communication with the media content search module 25 and configured to identify one or more P2P MCFs that contain content similar or identical to a selected CPMCF. Identification of the one or more P2P MCFs may entail, for example, comparing aspects of each P2P MCF to corresponding aspects of the selected CPMCF and computing a numerical relevance score for each P2P MCF based on the comparison.

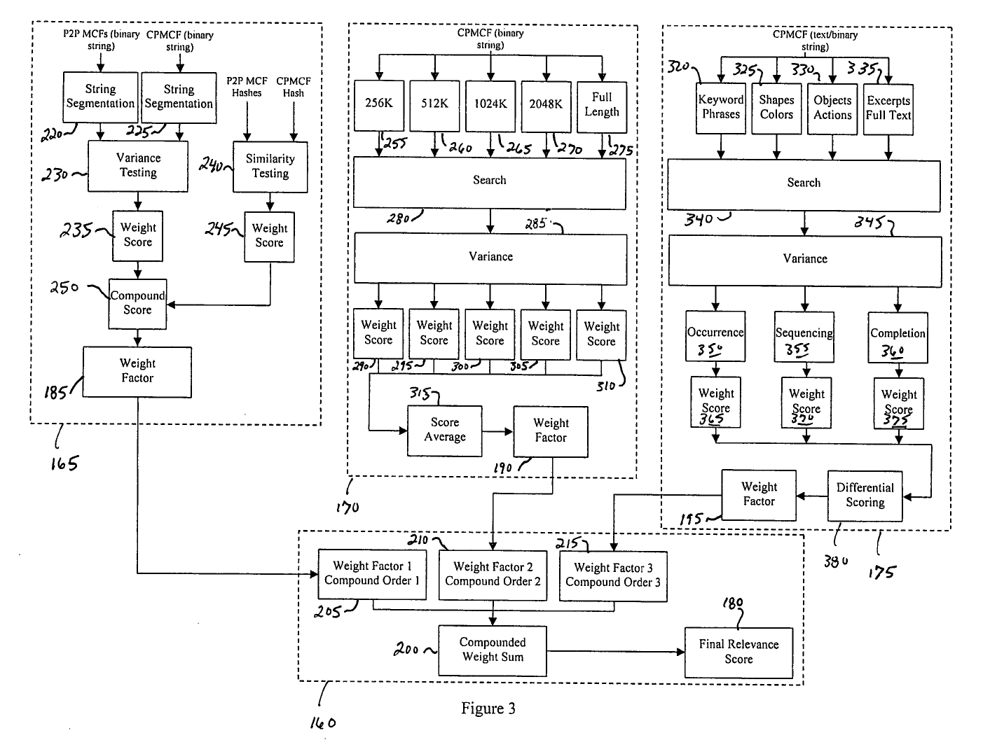

FIG. 3 illustrates a block diagram of the relevancy sorter module 30 of FIG. 1, according to various embodiments. As shown, the relevancy sorter module 30 may include a relevance score computation block 160, a first weight factor computation block 165, a second weight factor computation block 170, and a third weight factor computation block 175. Within the relevance score computation block 160, a numerical relevance score for each P2P MCF may be computed at block 180 based upon a sum of a first weight factor, a second weight factor, and a third weight factor computed at blocks 185, 190, and 195 located within the first, second, and third weight factor computation blocks 165, 170, 175, respectively. Prior to computing the sum of the first, second, and third weight factors at block 200, each of the first, second and third weight factors be combined with a bias component at blocks 205, 210, and 215. For example, if the first weight factor is of greater significance than the second and third weight factors, the first weight factor may be upwardly adjusted at block 205 including a bias component greater with the first weight factor. Alternatively, the second and third weight factors may be downwardly adjusted at blocks 210, 215 by including a bias component than one therewith.

According to various embodiments, the first weight factor of block 185 may be computed for each P2P MCF based upon (1) a comparison of the file format reader parsing algorithm output for each P2P MCF with the corresponding output for the selected CPMCF, and (2) a determination of the similarity between one or more cryptographic signatures for each P2P MCF and the corresponding signatures of the selected CPMCF. According to various embodiments, the binary string outputs generated by applying the file format reader parsing algorithm to each P2P MCF and to the selected CPMCF may be segmented into 256-bit segments (or other suitably sized segments) at blocks 220 and 225, respectively. At block 230, each 256-bit segment associated with a given P2P MCF may be compared with the corresponding 256-bit segment of the selected CPMCF content file. For each segment-based comparison, the variance (i.e., the degree of difference between the segments) may be computed using known methods in order to detect alterations, masking errors, and distortion. For each P2P MCF/CPMCF comparison, a first weight score based upon the computed variances for the 256-bit segment comparisons may be computed at block 235. At block 240, cryptographic signatures for each P2P MCF may be compared to the corresponding signatures of the selected CPMCF to determine their similarity. A second weight score may be computed at block 245 based upon each signature comparison. The first and second weight scores may then be combined at block 250 to determine the first weighting factor of block 185.

According to various embodiments, in cases where the CPMCF is of a music, voice, or video file type, the second weight factor of block 190 may be computed for each P2P MCF based upon pattern-based searches of the binary output index 120. Search strings used to perform the pattern-based searches may be derived from the binary string generated by processing the selected CPMCF using the binary output conversion parsing algorithm. The data in the binary output index 120 to be searched comprises the binary strings derived by processing each P2P MCF using the binary output conversion parsing algorithm, as described above.

According to various embodiments, the search strings may be created by segmenting the binary string into 256, 512, 1024, and 2048-bit segments at blocks 255, 260, 265, and 270, respectively. For example, segmentation of a binary string one megabyte (i.e., 1,048,576 bytes) in size will produce 4096 256-bit search strings, 2048 512-bit search strings, 1024 1024-bit search strings, and 512 2048-bit search strings. Additionally, a full-length search string (i.e., one 1 Mb search string, according to the preceding example) may be created at block 275.

Each set of search strings may be processed by the pattern search module 140 at block 280. For each search string of a given search string size, a subset of the P2P MCFs may be identified that contain binary strings similar or identical to the search string. For each P2P MCF within the identified subset, the variance between the search string and the binary string of the P2P MCF that resulted in the match may be computed at block 285 using known methods. The variance computed for each file within each subset may be combined with similarly-computed and corresponding variances from other subsets in order to compute a variance score for each P2P MCF for each search string size. The weight scores for the P2P MCFs for the 256, 512, 1024, 2048-bit search strings, as well as the full-length search string, may be computed at blocks 290, 295, 300, 305, and 310 of FIG. 3, respectively. An overall variance score for each P2P MCF may be computed at block 315 by averaging the variance scores for each P2P MCF for each string size. According to various embodiments, when computing the overall variance score for each P2P MCF, the individual variance scores may be biased based upon search string size. For example, when averaging the variances corresponding to the 256-bit, 512-bit, 1024 bit, 2048-bit, and full-length search string lengths for a given P2P MCF, the variance corresponding to the full-length search string may be biased most heavily, and the variance corresponding to the 256-bit search size may be biased the least heavily. The weight factor for each P2P MCF computed at block 190 corresponds to the overall variance score for each file computed at block 315.

According to various embodiments, in cases where the CPMCF is of an image, video, document, or voice file type, the third weight factor of block 195 may be computed for each P2P MCF based upon context-based searches of the speech-to-text and OCR index 130. Search strings used to perform the context-based searches may be derived from the outputs generated by processing the CPMCF using one or more of the speech-to-text conversion parsing algorithm, the OCR parsing algorithm, the voice/sound capture recognition parsing algorithm, and the video/image capture recognition parsing algorithm. The data in the speech-to-text and OCR index 130 to be searched comprises the text and binary strings derived by processing each P2P MCF using these algorithms, as described above.

According to various embodiments, the search strings may be created by segmenting the parser algorithm outputs corresponding to the CPMCF into general categories such as, for example, keywords and phrases, shapes and colors, objects and actions, and full texts and text excerpts. As shown in FIG. 3, segmentation of the parser algorithm outputs into these categories may be performed at blocks 320, 325, 330, and 335, respectively. These categories are provided by way of example only, and one skilled in the art will appreciate that segmentation of the CPMCF based upon one or more additional and/or alternative categories may be desirable.

The search strings may be processed by the context search module 145 at block 340. For each search string within a given category, a subset of the P2P MCFs may be identified that contain text or binary strings similar or identical to the search string. For each P2P MCF within the identified subset, variance between the search string and the binary or text string of the P2P MCF resulting in the match may be computed at block 345 using known methods. The variance computed for each file within each subset may be combined with similarly-computed and corresponding variances from other subsets in order to compute a variance score for each P2P MCF within a given category. An overall variance score for each P2P MCF may be computed by averaging the variance scores for each P2P MCF across all of the categories. According to various embodiments, when computing the overall variance score for each P2P MCF, the individual variance scores may be biased based upon the relative amount of content in each category. For example, where the content in a keywords category for a given P2P MCF exceeds the amount of content in a shapes category for the same file, the variance associated with the keywords category may be biased more heavily than the variance associated with the shapes category.

In addition to computing variance scores for each P2P MCF, occurrence, sequencing, and completion testing may be performed for each P2P MCF at blocks 350, 355, and 360, respectively. Weight corresponding to the occurrence, sequencing, and completion tests may be generated a blocks 365, 370, and 375, respectively. The occurrence score reflects the frequency with which a search string is replicated within a P2P MCF. The sequence score reflects the degree to which the order of the search string terms is replicated in a P2P MCF. The completion score reflects the degree to which each of the search string terms is replicated in a P2P MCF. At block 380, differential analysis may be conducted between each of the occurrence, sequence, and completion scores to determine an appropriate weighting for each score. The occurrence, sequence, and completion scores for each P2P MCF may then be combined with the corresponding overall variance score computed at block 345 in order to compute the third weight factor of block 195.

As shown in FIG. 1, the relevancy output module 35 may be in communication with the relevancy sorter module 30 and comprise a media search report module 150 and a content tag module 155. According to various embodiments, the search report module 150 may be configured to rank and output the relevance scores computed by the relevancy sorter module 30 in a most-relevant to least-relevant format. The content tag module 155 may be configured to identify the content tag (e.g., the MFIDN) of the corresponding P2P MCF associated with each score.

According to various embodiments, the modules described above may be implemented as software code that is executed by one or more processors associated with the system 10. The software code may be written using any suitable computer language such as, for example, Java, C, C++, Virtual Basic or Perl using, for example, conventional or object-oriented techniques. The software code may be stored as a series of instructions or commands on a computer-readable medium, such as a random access memory (RAM), a read-only memory (ROM), a magnetic medium such as a hard drive or a floppy disk, or an optical medium, such as a CD-ROM or DVD-ROM.

Whereas particular embodiments of the invention have been described herein for the purpose of illustrating the invention and not for the purpose of limiting the same, it will be appreciated by those of ordinary skill in the art that numerous variations of the details, materials, configurations and arrangement of components may be made within the principle and scope of the invention without departing from the spirit of the invention. For example, the steps of certain of the processes and algorithms described above may be performed in different orders. The preceding description, therefore, is not meant to limit the scope of the invention.

What is claimed is:

1. A system for determining the existence of pre-determined media content within a media content collection, the system comprising:
a media content processing module configured for:
collecting one or more media content files from one or more external peer-to-peer networks to form the media content collection;
generating one or more classification parameter values based upon a corresponding one or more attributes of the media content file for each of the one or more collected media content files;
applying one or more parsing algorithms to at least one of the media content file and the one or more classification parameter values corresponding thereto for each of the one or more collected media content files; and
generating one or more searchable indices based upon outputs from the one or more parsing algorithms; and
a media content search module in communication with the media content processing module, wherein the media content search module is configured for applying a search algorithm to at least one of the one or more searchable indices based upon one or more search strings input thereto.

2. The system of claim 1, wherein the one or more external peer-to-peer networks comprise at least one Internet-based peer-to-peer network.

3. The system of claim 1, wherein the one or more media content files comprise at least one of the following: an audio media content file, an image media content file, a video media content file, and a document media content file.

4. The system of claim 1, wherein the one or more file attributes comprise at least one of the following: a file name, a file size, a file type, and a file format.

5. The system of claim 1, wherein the one or more parsing algorithms comprise at least one of the following: a file format reader parsing algorithm, a cryptographic signature hashing parsing algorithm, a binary output conversion parsing algorithm, a speech-to-text conversion parsing algorithm, an optical character recognition parsing algorithm, a voice capture recognition parsing algorithm, a sound capture recognition parsing algorithm, a video capture recognition parsing algorithm, and an image capture recognition parsing algorithm.

6. The system of claim 1, wherein the search algorithm comprises at least one of the following: a pattern-based search algorithm and a context-based search algorithm.

7. The system of claim 1, wherein the one or more search strings comprise at least one search string derived from the pre-determined media content.

8. The system of claim 1, wherein the pre-determined media content comprises media content that is subject to a restriction with respect to one or more of the following: copy, use, and distribution.

9. The system of claim 1, wherein the system further comprises a relevancy sorter module configured for computing a relevance score for at least one of the one or more collected media content files.

10. The system of claim 9, wherein the relevancy score is based on at least one of the following: a first, second, and third weight factor.

11. The system of claim 10, wherein the first weight factor comprises a first component and a second component, wherein the a first component is computed by applying a file format reader parsing algorithm to the media content file and comparing the corresponding output of the file format reader parsing algorithm to the output of the file format reader parsing algorithm when applied to the pre-determined content.

12. The system of claim 11, wherein the second component is computed by comparing one or more cryptographic signatures derived from the media content file to a corresponding one or more cryptographic signatures derived from the pre-determined media content.

13. The system of claim 10, wherein the second weight factor is computed by performing a plurality of searches of at least one of the one or more searchable indices using a corresponding plurality of search strings, wherein the corresponding plurality of search strings is derived from the pre-determined media content by applying a binary output conversion parsing algorithm thereto.

14. The system of claim 10, wherein the third weight factor comprises a first component and a second component, wherein the first component is computed by performing one or more searches of at least one of the one or more searchable indices using a corresponding one or more search strings, wherein the one or more search strings are derived from the pre-determined media content by applying at least one of a speech-to-text conversion parsing algorithm, an optical character recognition parsing algorithm, a voice capture recognition parsing algorithm, a sound capture recognition parsing algorithm, a video capture recognition parsing algorithm, and an image capture recognition parsing algorithm thereto.

15. The system of claim 14, wherein the second component is computed based on at least one of an occurrence score, a sequencing score, and a completion score.

16. The system of claim 10, wherein at least one of the first, second, and third weight factors include a bias component.

17. A method of determining the existence of pre-determined media content within a media content collection, the method comprising:
collecting one or more media content files from one or more external peer-to-peer networks to form the media content collection;
generating one or more classification parameter values based upon a corresponding one or more attributes of the media content file for each of the one or more collected media content files;
applying one or more parsing algorithms to at least one of the media content file and the one or more classification parameter values corresponding thereto for each of the one or more collected media content files;
generating one or more searchable indices based upon outputs from the one or more parsing algorithms; and
applying a search algorithm to at least one of the one or more searchable indices based upon one or more search strings input thereto.

18. The method of claim 17, further comprising computing a relevance score for at least one of the one or more collected media content files.

19. The method of claim 18, wherein computing the relevance score comprises computing at least one of the following: a first, second, and third weight factor.

20. A computer readable medium having stored thereon instructions which, when executed by a processor, cause the processor to:
collect one or more media content files from one or more external peer-to-peer networks to form a media content collection;
generate one or more classification parameter values based upon a corresponding one or more attributes of the media content file for each of the one or more collected media content files;
apply one or more parsing algorithms to at least one of the media content file and the one or more classification parameter values corresponding thereto for each of the one or more collected media content files;
generate one or more searchable indices based upon outputs from the one or more parsing algorithms; and
apply a search algorithm to at least one of the one or more searchable indices based upon one or more search strings input thereto.
